(19) United States
(12) Patent Application Publication
(10) Pub. No.: US 2025/0389360 A1
(43) Pub. Date: Dec. 25, 2025

(54) FLUID COUPLINGS

(71) Applicant: Colder Products Company, Roseville, MN (US)

(72) Inventors: La Her, Columbus, MN (US); Jack T. Stangl, Falcon Heights, MN (US)

(21) Appl. No.: 19/246,033

(22) Filed: Jun. 23, 2025

Related U.S. Application Data
(60) Provisional application No. 63/663,482, filed on Jun. 24, 2024.

(51) Int. Cl. F16L 37/34

(52) U.S. Cl. CPC F16L 37/34

(57) ABSTRACT

Fluid coupling devices can be used in fluid handling systems. Some fluid couplings include multiple rigid components, two fluid seal members, and a seal spacer that is mechanically captured and/or clamped between rigid components of the fluid coupling. Such seal spacers can be used to separate the two fluid seal members and to position the fluid seal members in desired operational positions.

### CROSS-REFERENCE TO RELATED APPLICATIONS

This application claims the benefit of U.S. Provisional Application Ser. No. 63/663,482 filed Jun. 24, 2024. The disclosure of the prior application is considered part of (and is incorporated by reference in) the disclosure of this application.

### BACKGROUND

### 1. Technical Field

This document relates to fluid coupling devices for fluid systems and methods of making and/or using the fluid coupling devices. For example, some embodiments described in this document relate to fluid couplings that have seal spacers that are mechanically captured between rigid components of the fluid coupling.

### 2. Background Information

Fluid systems commonly include components such as tubing, pumps, reservoirs, fittings, couplings, heat exchangers, sensors, filters, valves, seals, and the like. Such components can be connected together in a network to define one or more fluid flow paths. Fluids may be moved through fluid systems using fluid pressure differentials. For example, in some cases, a pump or a vacuum source is used to create a pressure differential that causes the fluid to flow within the fluid system. In another example, gravity is used to cause the fluid to flow within the fluid system. In other examples, a combination of such techniques is used to cause the fluid to flow within the fluid system.

Some fluid couplings include seal members that are positioned between components of the fluid couplings or between the fluid coupling and a second fluid coupling that are mated together.

### SUMMARY

This document describes fluid coupling devices for fluid systems and methods of making and/or using the fluid coupling devices. For example, some embodiments described in this document include fluid couplings that have seal spacers that are mechanically captured between rigid components of the fluid coupling. Such seal spacers can be used to separate two fluid seal members.

In one aspect, this disclosure is directed to a fluid coupling device that includes a main body defining: (i) an open end configured to receive a mated fluid coupling, (ii) an internal space, and (iii) a longitudinal axis, the main body comprising termination end that is opposite of the open end; a valve cartridge housing disposed within the internal space; a valve stem extending along the longitudinal axis within the valve cartridge housing; a valve sleeve surrounding a portion of the valve stem and being movable along the valve stem between a first position in which a fluid flow path is open through the fluid coupling and a second position in which the fluid flow path is closed; a first seal arranged to fluidly seal between the valve sleeve and the valve cartridge housing while the valve sleeve is in the second position; a second seal arranged to fluidly seal between the main body and a mated fluid coupling; and a seal spacer. The seal spacer comprises a first portion disposed between and facing directly at the first and second seals; and a second portion disposed between and abutting against the valve cartridge housing and the main body.

Such a fluid coupling device may optionally include one or more of the following features. The second portion of the seal spacer may be mechanically captured or clamped between the valve cartridge housing and the main body. The seal spacer may have a T-shaped cross-sectional shape. The second seal may be captured between the seal spacer and the main body. A portion of the valve sleeve may be within an inner diameter of the seal spacer while the valve sleeve is in the second position. The fluid coupling may also include a valve spring, and wherein the valve spring biases the valve sleeve to the second position. The valve stem may be affixed to the valve cartridge housing.

In another aspect, this disclosure is directed to a fluid coupling that includes rigid components; two seal members; and a seal spacer that is mechanically clamped or captured between the rigid components and that physically separates the two seal members such that each seal member of the two seal members is directly adjacent an opposite side of the seal spacer.

Such a fluid coupling may optionally include one or more of the following features. The rigid components may include a main body. The seal spacer may be mechanically clamped or captured between the main body and an additional component of the rigid components. The additional component of the rigid components may be a valve cartridge housing. An inner diameter surface of a first seal member of the two seal members fluidly may seal against a movable valve member. An inner diameter surface of a second seal member of the two seal members may be out of contact with any other part of the fluid coupling and/or may be arranged to fluidly seal against a second fluid coupling when the second fluid coupling is mated with the fluid coupling.

Particular embodiments of the subject matter described in this document can be implemented to realize one or more of the following advantages. The fluid coupling embodiments described herein include a seal spacer. The seal spacer is a component part of the fluid coupling that helps to accurately position two seal members in advantageous operational positions within the fluid coupling. In some embodiments, the seal spacer is mechanically clamped/captured in a fixed position by other rigid components of the fluid coupling. This provides advantages such as, but not limited to, accurate positioning of the seal spacer (and the seal members), efficient component manufacturing, and an efficient process of assembling the fluid coupling. The seal spacer can also help to prevent movement of the seals when pressure is applied to the system/coupling.

Unless otherwise defined, all technical and scientific terms used herein have the same meaning as commonly understood by one of ordinary skill in the art to which this disclosure pertains. In addition, the materials, methods, and examples of the embodiments described herein are illustrative only and not intended to be limiting.

In the context of this disclosure, the term “fluid” also includes gases, liquids, vapors, steam, mists, gels, semi-solids, powders, and the like, without limitation.

The details of one or more embodiments of the invention are set forth in the accompanying drawings and the description herein. Other features, objects, and advantages of the invention will be apparent from the description and drawings, and from the claims.

### DESCRIPTION OF THE DRAWINGS

FIG. 1 is a perspective view of an example fluid coupling device, in accordance with some embodiments described herein.

FIG. 2 is a longitudinal cross-sectional view of the fluid coupling device of FIG. 1.

FIG. 3 illustrates an enlarged portion of FIG. 2.

FIG. 4 is a perspective view of an example seal spacer that can be used in the fluid coupling device of FIG. 1.

FIG. 5 is a longitudinal cross-sectional view of the seal spacer of FIG. 4.

FIG. 6 is a perspective view of the fluid coupling device of FIG. 1 with a mated fluid coupling device in accordance with some embodiments.

FIG. 7 is longitudinal cross-sectional view of the mated fluid coupling devices of FIG. 6.

FIG. 8 is another top perspective view of the fluid couplings devices described herein.

FIG. 9 is a front view of the of the fluid couplings devices described herein.

FIG. 10 is a rear view of the fluid couplings devices described herein.

FIG. 11 is a left-side view of the fluid couplings devices described herein.

FIG. 12 is a right-side view of the fluid couplings devices described herein.

FIG. 13 is a top view of the fluid couplings devices described herein.

FIG. 14 is a bottom view of the fluid couplings devices described herein.

### DETAILED DESCRIPTION OF ILLUSTRATIVE EMBODIMENTS

This document describes fluid coupling devices for fluid systems and methods of making and/or using the fluid coupling devices. For example, some embodiments described in this document include fluid couplings that have seal spacers that are mechanically clamped/captured between rigid components of the fluid coupling. Such seal spacers can be used to separate two fluid seal members and to position the fluid seal members in desired operational positions.

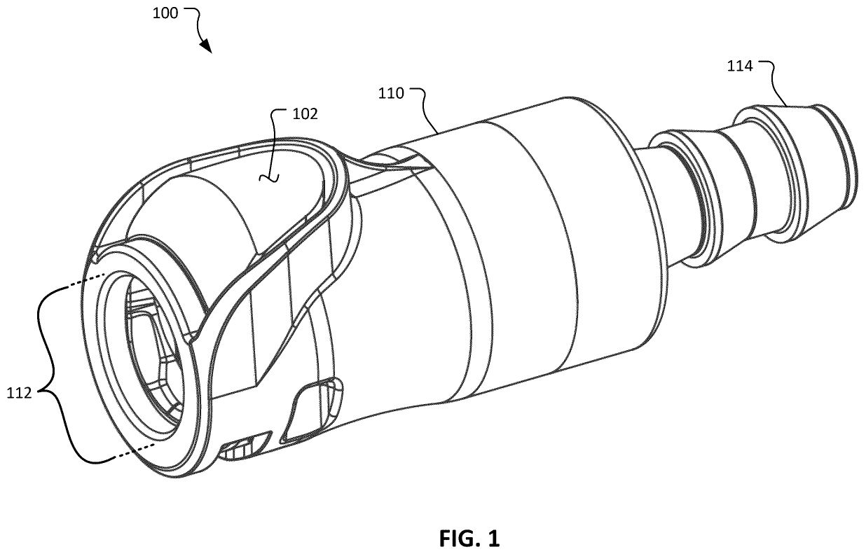

FIGS. 1-3 illustrate an example female fluid coupling device 100 (or “female fluid coupling 100,” or simply “coupling 100”). The coupling 100, broadly speaking, includes a housing 110 (or “main body 110”). The main body 110 defines an internal space, a longitudinal axis 101, and an open end 112. The main body 110 includes a termination 114 extending from an end of the main body 110 that is opposite of the open end 112.

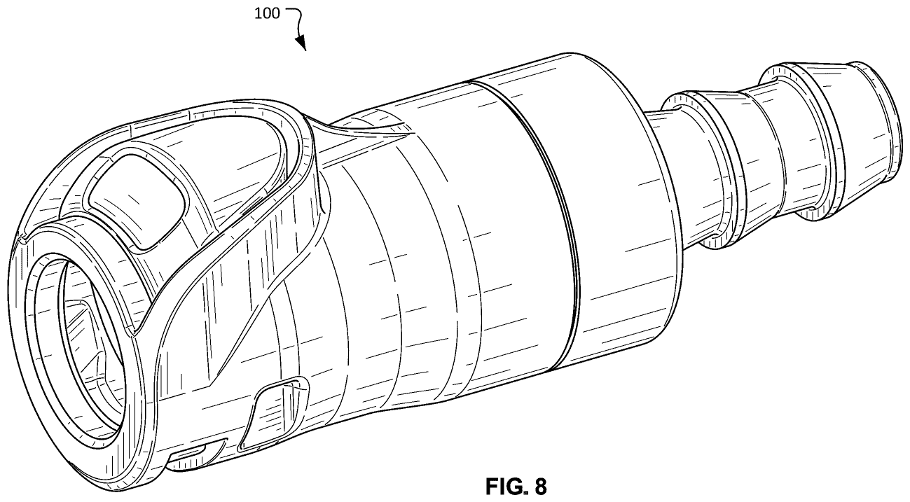

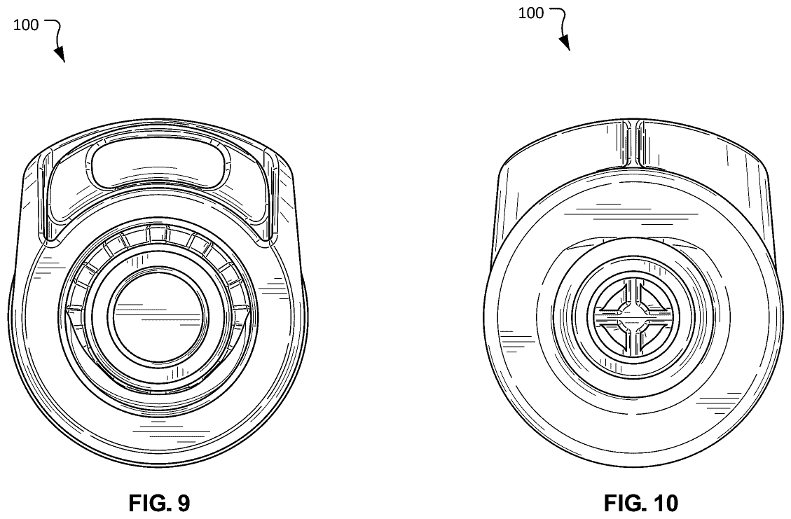

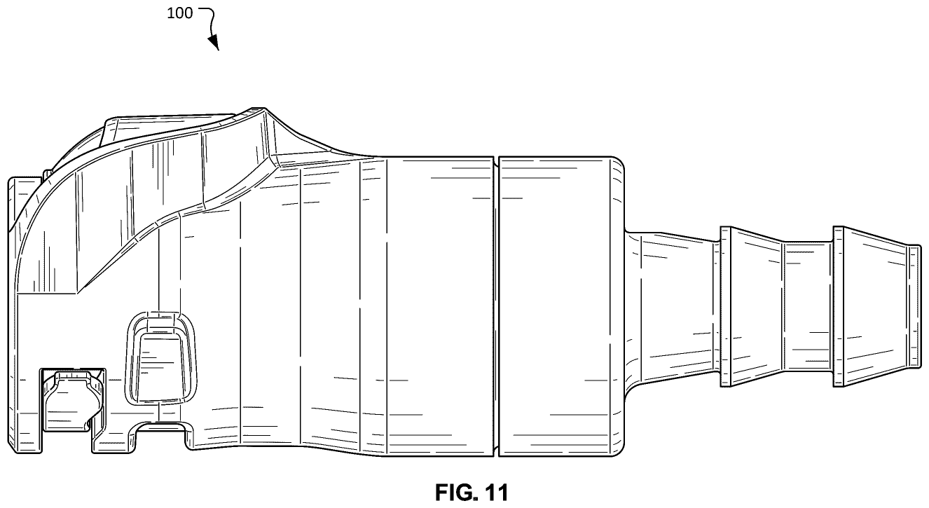

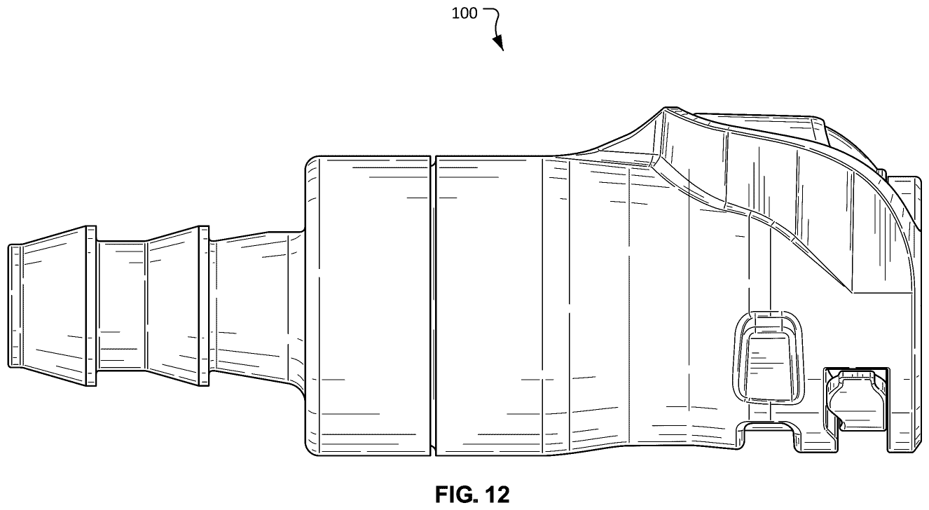

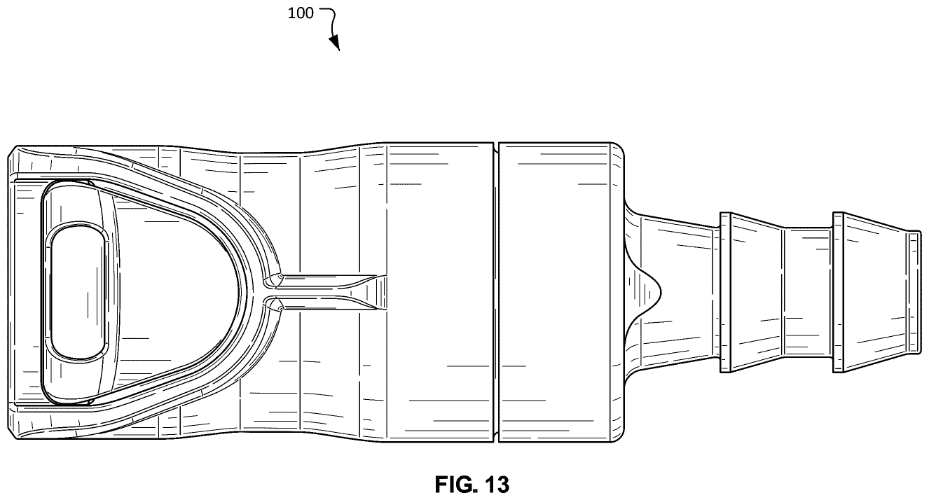

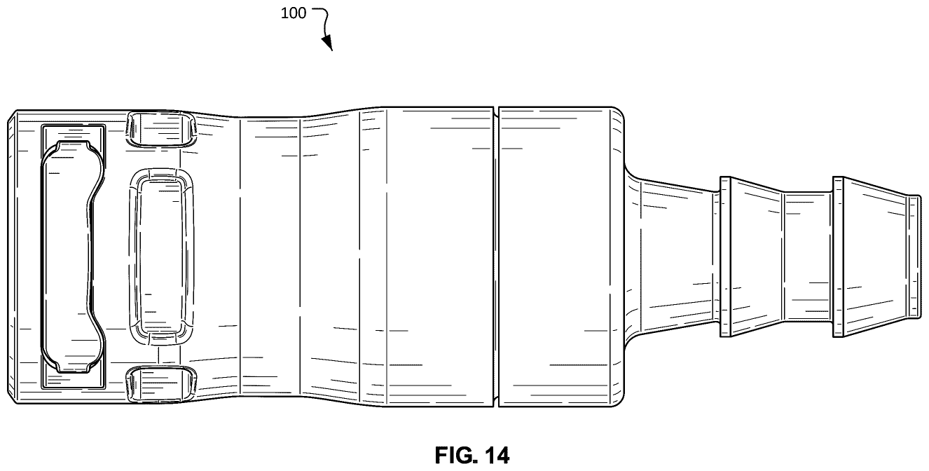

The open end 112 is configured to receive a portion of another fluid coupling (e.g., male fluid coupling 200, as shown in FIGS. 6 and 7) that is mated or mate-able to the fluid coupling 100. In the depicted embodiment, the fluid coupling 100 includes a manually depressible clip member 102 that can releasably latch a mated fluid coupling in an operable configuration to/with the fluid coupling 100 (e.g., as shown in FIGS. 6 and 7).

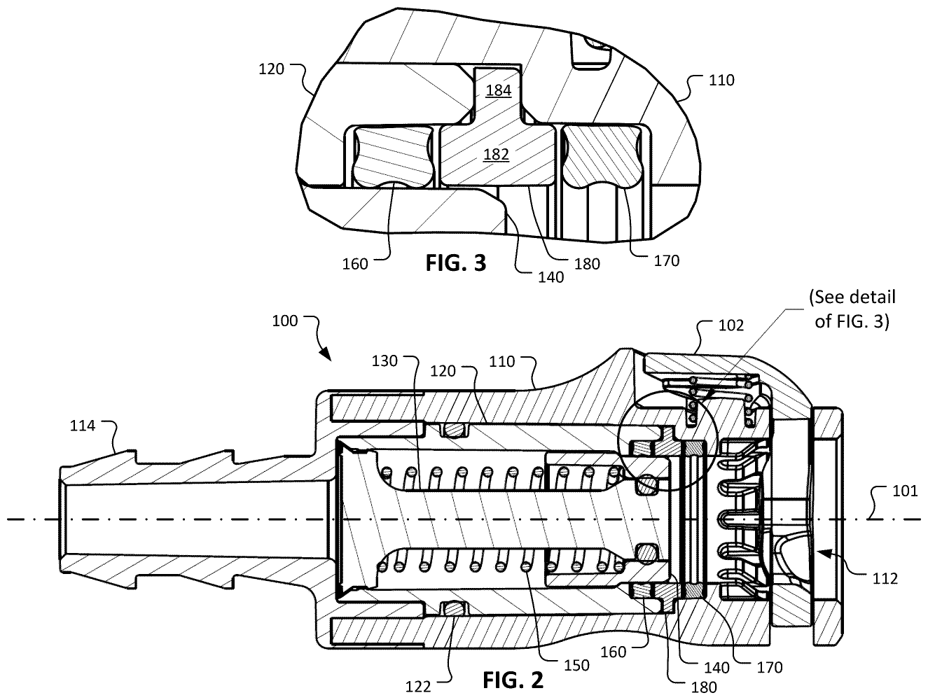

The coupling 100 also includes a valve cartridge housing 120 disposed within the internal space of the main body 110; a valve stem 130 affixed to the valve cartridge housing 120 and extending along the longitudinal axis 101 within the valve cartridge housing 120; a valve sleeve 140 surrounding a portion of the valve stem 130 and being movable along the valve stem 130 (and the longitudinal axis 101) between a first/open position in which a fluid flow path is opened through the fluid coupling and a second position in which the fluid flow path is closed (as shown in FIG. 2); a valve spring 150 that biases the valve sleeve 140 to the second/closed position; a first seal 160 arranged to fluidly seal between the valve sleeve 140 and the valve cartridge housing 120 while the valve sleeve 140 is in the second/closed position; a second seal 170 arranged to fluidly seal between the main body 110 and a mated fluid coupling (not shown); and a seal spacer 180 (as described further below). A cartridge seal 122 is positioned between an outer diameter of the valve cartridge housing 120 and an inner diameter of the main body 110 to prevent fluid leakage therethrough.

The materials from which one or more of the components of the fluid coupling 100 are made of include thermoplastics or thermosets. In particular embodiments, the materials from which the components of the fluid coupling 100 are made of are thermoplastics, such as, but not limited to, acetal, ABS, polycarbonate, polysulfone, polyether ether ketone, polysulphide, polyester, polyvinylidene fluoride (PVDF), polyethylene, Perfluoropolymers (PFA, PTFE, PCTFE and the like), polyphenylsulfone (PPSU; e.g., Radel®), polyetherimide (PEI; e.g., Ultem®), polypropylene, polyphenylene, polyaryletherketone, and the like, and combinations thereof. In some embodiments, the thermoplastics can include one or more fillers such as, but not limited to, glass fiber, glass bead, carbon fiber, talc, etc.

In some embodiments, the materials from which one or more of the components of the fluid coupling 100 are made of include metals such as, but not limited to stainless steel, brass, aluminum, plated steel, zinc, and the like. In particular embodiments, the fluid coupling 100 is metallic-free.

In some embodiments, the fluid coupling 100 includes the spring 150. The spring 150 can be one or more plastic (e.g., PEEK, PPS, etc.) or metallic spring members (e.g., spring steel, stainless steel such as 316L, piano/music wire, beryllium copper, titanium, Hastelloy®, Inconel®, and the like).

In certain embodiments, the fluid coupling 100 includes one or more seal members, gaskets, or seals (e.g., the first seal 160 and the second seal 170). Such seal members, gaskets, or seals can be made of materials such as, but not limited to, silicone, fluoroelastomers (FKM), ethylene propylene diene monomer (EPDM), perfluoroelastomers (e.g., FFKM, Kalrez®, Chemraz® and the like), thermoplastic elastomers (TPE), buna, buna-N, thermoplastic vulcanizates (TPV), and the like. In some embodiments, the seal members, gaskets, or seals can have a cross-sectional shape that is an hourglass-shape, an oval shape, a circular shape, D-shaped, X-shaped, square, rectangular, U-shaped, L-shaped, V-shaped, a polygonal shape, a multi-lobe shape, or any other suitable shape, and combinations thereof, without limitation.

While the termination 114 is depicted as a barbed connection, it should be understood that the fluid coupling 100 can have any type of termination or connection such as, but not limited to, barbed fittings, threaded connections (e.g., straight thread or pipe thread), sanitary fittings, compression fittings, aseptic connections, quick connects, quick disconnects, hydraulic connections, luer fittings, solder connections, welded connections, and the like, and combinations thereof. Such connections can be straight (as depicted) or in another arrangement such as, but not limited to, a 90° elbow arrangement, a 45° elbow, a straight fitting, a Tee fitting, a Y-fitting, a push-fit connection, and so on. In some embodiments, the coupling 100 can be configured to be fluidly coupled with a fluid conduit such as, but not limited to, a tube, pipe, a manifold, and the like, without limitation.

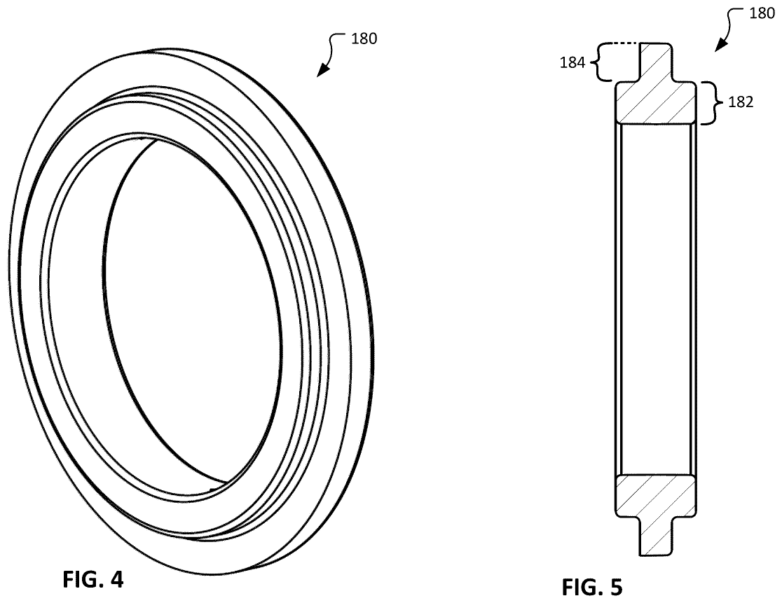

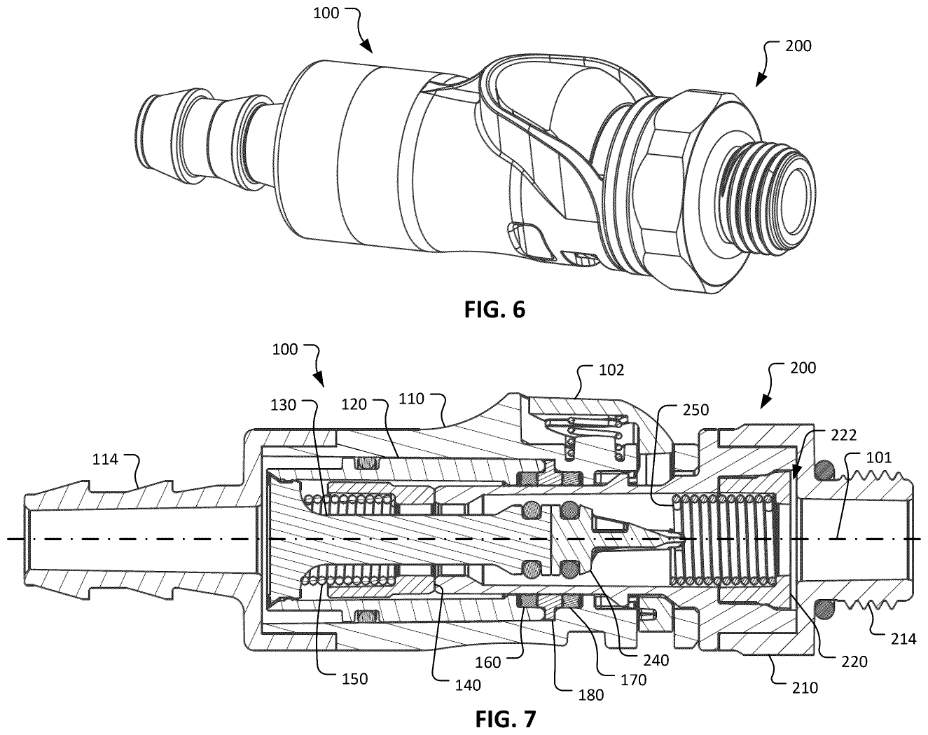

Referring also to FIGS. 4 and 5, the seal spacer 180 is a rigid or semi-rigid component that separates the first seal 160 and the second seal 170. In the depicted embodiment, the first seal 160 abuts one side of the seal spacer 180 and the second seal 170 abuts an opposite side of the seal spacer 180. That is, in the depicted embodiment the seal spacer 180 is the only component between the first seal 160 and the second seal 170.

In the depicted embodiment, the seal spacer 180 has a T-shaped cross-section. The T-shaped cross-section includes a first portion 182 (the two arms of the “T”) and a second portion 184 (the stem of the “T”). In the depicted embodiment, the first portion 182 and the second portion 184 are arranged at 90° relative to each other.

As best seen in FIG. 3, the first portion 182 is disposed between and facing directly at, or adjacent to, the first seal 160 and second seal 170. The second portion 184 is disposed between and abuts against an end annular surface of the valve cartridge housing 120. The second portion 184 also abuts against a shoulder of the main body 110. In some embodiments, the sides of the seal glands of seals 160 and 170 can be shaped to improve performance, such as to resist increased pressure or reduce seal drag/friction. That is, individual side surfaces of seals 160 and 170 can be concave, half dovetail, etc.

In particular embodiments, the second portion 184 of the seal spacer 180 is mechanically captured and/or clamped between the valve cartridge housing 120 and the main body 110. Accordingly, the position of the seal spacer 180 is thereby established in a fixed position in relation to other components of the fluid coupling 100.

The second seal 170 is captured between the seal spacer 180 and the main body 110. The first seal 160 is captured between the seal spacer 180 and the valve cartridge housing 120. In the depicted embodiment, a portion of the valve sleeve 140 is within an inner diameter of the seal spacer 180 while the valve sleeve 140 is in the second/closed position. The valve sleeve 140 is not within an inner diameter of the seal spacer 180 while the valve sleeve 140 is in the first/open position. The opened fluid flow path defined through the fluid coupling 100 (when the valve sleeve 140 is in the first/open position) passes through the inner diameter of the seal spacer 180.

Because the seal spacer 180 is mechanically clamped/captured between two rigid components of the fluid coupling 100, the seal spacer 180 accurately establishes the operational positions of the first seal 160 and the second seal 170. In some embodiments, there is a small recess in the main body 110 that receives an oversized seal spacer 180 such that the seal spacer 180 is pressed into place and is held by friction.

The seal spacer 180 and the valve cartridge housing 120 create a first annular internal groove that receives the first seal 160. The seal spacer 180 and the main body 110 create a second annular internal groove that receives the second seal 170. Such annular internal grooves are technically challenging or practically impossible to create using an injection molding process if the seal spacer 180 and the valve cartridge housing 120 and/or the seal spacer 180 and the main body 110 were unitary components. Accordingly, the use of the seal spacer 180 allows for the rigid components of the fluid coupling 100 to be made using efficient injection molding processes. Moreover, the use of the seal spacer 180 allows for an efficient assembly process of the fluid coupling 100.

Referring also to FIGS. 6 and 7, the female fluid coupling 100 can be coupled in an operable arrangement with an example male fluid coupling 200. The example male fluid coupling 200 includes a main body 210, a termination 214, a male valve member 240, a spring 250, and a spring retainer 220. The spring retainer 220 is affixed (e.g., press-fit, welded, adhered, etc.) to the main body 210. In the depicted embodiment, there is a space/gap 222 defined between the spring retainer 220 and the termination 214.

To arrive at the depicted arrangement, a portion of the male fluid coupling 200 has been inserted into/within the open end 112 of the female fluid coupling 100 along the longitudinal axis 101. The insertion process causes the valve sleeve 140 to translate along the longitudinal axis 101 to its first/open position (also resulting in compression of the spring 150), and the male valve member 240 to translate along the longitudinal axis 101 to its first/open position (also resulting in compression of the spring 250). Accordingly, with both valves in their open positions, an open fluid flow path is established through the female fluid coupling 100 and the male fluid coupling 200 (between the termination 114 and the termination 214).

### Additional Optional Features and Embodiments

While in the depicted embodiment, the coupling 100 has a valve arrangement (e.g., the valve stem 130, the valve sleeve 140, and the valve spring 150), in some cases the coupling 100 (and/or the male fluid coupling 200) does not have a valve arrangement or has another type of valve arrangement.

While the embodiments of the coupling 100 (and/or the male fluid coupling 200) described herein are normally closed fluid couplings, in some embodiments the valves of the fluid coupling devices can be configured to be normally open.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described herein as acting in certain combinations and even initially claimed as such, one or more features from a claimed combination can, in some cases, be excised from the combination, and the claimed combination may be directed to a subcombination or variation of a subcombination.

What is claimed is:

1. A fluid coupling comprising:
a main body defining: (i) an open end configured to receive a mated fluid coupling, (ii) an internal space, and (iii) a longitudinal axis, the main body comprising termination end that is opposite of the open end;
a valve cartridge housing disposed within the internal space;
a valve stem extending along the longitudinal axis within the valve cartridge housing;
a valve sleeve surrounding a portion of the valve stem and being movable along the valve stem between a first position in which a fluid flow path is open through the fluid coupling and a second position in which the fluid flow path is closed;
a first seal arranged to fluidly seal between the valve sleeve and the valve cartridge housing while the valve sleeve is in the second position;
a second seal arranged to fluidly seal between the main body and a mated fluid coupling; and
a seal spacer comprising:
a first portion disposed between and facing directly at the first and second seals; and
a second portion disposed between and abutting against the valve cartridge housing and the main body.

2. The fluid coupling of claim 1, wherein the second portion of the seal spacer is mechanically captured or clamped between the valve cartridge housing and the main body.

3. The fluid coupling of claim 1, wherein the seal spacer has a T-shaped cross-sectional shape.

4. The fluid coupling of claim 1, wherein the second seal is captured between the seal spacer and the main body.

5. The fluid coupling of claim 1, wherein a portion of the valve sleeve is within an inner diameter of the seal spacer while the valve sleeve is in the second position.

6. The fluid coupling of claim 1, further comprising a valve spring, and wherein the valve spring biases the valve sleeve to the second position.

7. The fluid coupling of claim 1, wherein the valve stem is affixed to the valve cartridge housing.

8. The fluid coupling of claim 1, further comprising a cartridge seal disposed between an outer diameter of the valve cartridge housing and an inner diameter of the main body.

9. A fluid coupling comprising:
rigid components;
two seal members; and
a seal spacer that is mechanically clamped or captured between the rigid components and that physically separates the two seal members such that each seal member of the two seal members is directly adjacent an opposite side of the seal spacer.

10. The fluid coupling of claim 9, wherein the rigid components comprise a main body, and wherein the seal spacer is mechanically clamped or captured between the main body and an additional component of the rigid components.

11. The fluid coupling of claim 10, wherein the additional component of the rigid components is a valve cartridge housing.

12. The fluid coupling of claim 9, wherein an inner diameter surface of a first seal member of the two seal members fluidly seals against a movable valve member.

13. The fluid coupling of claim 12, wherein an inner diameter surface of a second seal member of the two seal members is out of contact with any other part of the fluid coupling and is arranged to fluidly seal against a second fluid coupling when the second fluid coupling is mated with the fluid coupling.
